(19) United States
(12) Patent Application Publication
(10) Pub. No.: US 2004/0011132 A1
(43) Pub. Date: Jan. 22, 2004

(54) Method for the non-destructive testing of a composite conductor rail

(76) Inventor: Timo Netzel, Dessau (DE)

Correspondence Address: BACHMAN & LAPOINTE, P.C., 900 CHAPEL STREET, SUITE 1201, NEW HAVEN, CT, 06510, US

(21) Appl. No.: 10/441,356

(22) Filed: May 20, 2003

(30) Foreign Application Priority Data
May 30, 2002 (EP) 02 405 434.8

(51) Int. Cl. G01N 29/18; G01B 17/02

(52) U.S. Cl. 73/597

(57) ABSTRACT

A method for the non-destructive testing of the abrasion behavior of a composite conductor rail comprising a supporting element made of aluminium and a low-wear strip-like supporting surface made of stainless steel which is subjected to abrasion by dragging electrical current collectors. The method comprises transmitting pulses of ultrasonic energy are transmitted by an ultrasonic energy transmitter/receiver to the steel strip supporting surface at selected testing points. The difference in the running time between the pulses of ultrasonic energy reflected at the contact face and those reflected at the back of the steel strip supporting surface is measured The local thicknesses of the steel strip supporting surface at the selected testing points are calculated from the difference in running time and the sound velocity in the steel supporting surface.

### BACKGROUND OF THE INVENTION

The invention relates to a method for the non-destructive testing of the abrasion behavior of a composite conductor rail comprising a supporting element made of aluminium and a low-wear strip-like supporting surface made of stainless steel which is subjected to abrasion by dragging electrical current collectors.

Composite conductor rails generally consist of a supporting element made of aluminium conducting the electrical current, comprising a low-wear strip-like supporting surface made of stainless steel. In operation, electrical current collectors drag on the steel strip supporting surface of the composite conductor rail. The dragging contact leads to abrasion on the steel strip supporting surface, the abrasion occurring at the edges or in the centre of the supporting surface depending on the type of current collector and the resting angle of the current collector on the steel strip supporting surface.

Composite conductor rails have to be examined periodically for abrasion and optionally replaced. The abrasion behavior of the conductor rails provides information on the service life of the system. By determining the abrasion locally varying pressure forces and setting angles of the current collector on the steel strip supporting surface can be established over the width of a conductor rail and technical corrections can optionally be carried out, for example by adjusting the current collector. However, the soonest possible recognition of an uneven abrasion behavior assumes a measuring behavior with which the local residual thickness of the steel strip supporting surface can be determined with an adequate degree of accuracy.

The conventional methods for determining abrasion of composite conductor rails nowadays are based on mechanical measurement of the residual thickness of the steel strip supporting surface. The vernier callipers used for this purpose and measuring gauges lead to unsatisfactory results, however, as the abrasion often does not take place uniformly over the entire width of the steel strip supporting surface, but frequently at one or both edges or in the centre. In the case of an uneven abrasion of this type, a vernier calliper leads to an imprecise result, as the measurement takes place over the entire width. Although a measuring gauge can lead to somewhat better results, measurements can, however, only be undertaken in the disassembled state of the conductor rail. In addition, the current rail has to be partially destroyed in this method to determine the residual thickness of the steel strip supporting surface.

The object of the invention is to provide a non-destructive testing method, by which the abrasion behavior of the composite conductor rails of the type mentioned at the outset can be determined simply and without disassembling the conductor rails, by precisely measuring the local thickness of the steel strip supporting surface.

### SUMMARY OF THE INVENTION

The foregoing object is achieved by the present invention wherein, at selected testing points, pulses of ultrasonic energy are transmitted to the steel strip supporting surface, the difference in the running time between the pulses of ultrasonic energy reflected at the contact face and those at the back of the steel strip supporting surface is measured and the local thicknesses of the steel strip supporting surface at the selected testing points are calculated from the difference in running time and the sound velocity in the steel supporting surface.

An ultrasonic energy transmitter/receiver is set up at the selected testing points directly on the steel strip supporting surface in a preferred embodiment of the method according to the invention.

In conventional composite conductor rails the thickness of the steel strip supporting surface is between about 4 and 6 mm. For this thickness range a frequency of pulses of ultrasonic energy of between 6 and 10 MHz, in particular about 8 MHz, proves to be suitable.

### BRIEF DESCRIPTION OF THE DRAWINGS

Advantages, features and details of the invention emerge from the following description of preferred embodiments and with reference to the drawings in which, schematically,

FIG. 1 shows the cross-section through a composite conductor rail;

FIG. 2 shows the principle of non-destructive testing of the composite conductor rail from FIG. 1 with average abrasion.

### DETAILED DESCRIPTION

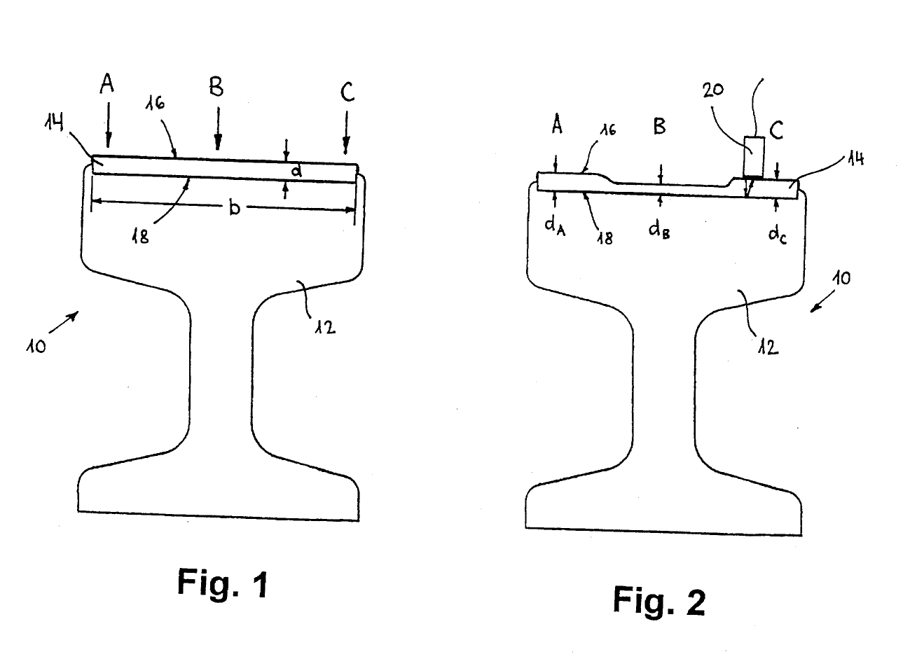

A composite conductor rail 10 shown in FIG. 1 has a supporting element 12 made of aluminium with a supporting surface 14 made of stainless steel. The width b of the steel strip supporting surface 14 is, for example 50 mm. The thickness d, for example, is 5 mm. A production type of the composite conductor rail 10 is, for example, disclosed in U.S. Pat. No. 4,167,866.

The abrasion occurring in practice owing to dragging electrical current collectors on the steel strip supporting surface 14 frequently takes place at the left-hand edge A, on the right-hand edge C, at the two edges A, C or in the centre B. Therefore, to determine the abrasion behavior along a composite conductor rail 10, three respective measurements are carried out over the width b of the steel strip supporting surface at the edge-side test points A, C and in the centre B, for example every 500 mm, or for more precise determination, approximately every 200 to 300 mm.

In the composite conductor rail shown in FIG. 2 the abrasion on the steel strip supporting surface 14 has taken place approximately in the centre at the position B while on the left-hand side edge A and on the right-hand side edge B practically no abrasion can be established. This local abrasion behavior is easily determined with an ultrasonic energy transmitter/receiver 20, in that the difference in running time of the pulses of ultrasonic energy reflected at the contact surface 16 and on the back surface 18 of the steel strip supporting surface 14 are measured. With the knowledge of the sound velocity in the steel strip supporting surface 14, which can be determined on a steel strip with defined thickness, the local thicknesses d_{A,B,C} of the steel strip supporting surface 14 can easily be determined.

A suitable apparatus for measuring the thickness of the steel strip supporting surface is the Echo-meter 1073 from Karl Deutsch GmbH. The miniature testing head DSE 4.2/4 PB 8 has proved to be optimal. The measuring reliability is about +/−0.1 mm.

1. A method for the non-destructive testing of the abrasion behavior of a composite conductor rail comprising a supporting element made of aluminium and, on the supporting element, a low-wear stainless steel strip supporting surface, having a contact surface and a back surface wherein the contact surface is subjected to abrasion by the dragging of electrical current collectors, the method comprises the steps of: transmitting pulses of ultrasonic energy to the steel strip supporting surface at selected testing points; measuring the difference in running time between the pulses of ultrasonic energy reflected at the contact surface and those reflected at the back surface of the steel strip supporting surface; and calculating the local thicknesses of the steel strip supporting surface at the selected testing points from the difference in running time and sound velocity in the steel supporting surface.

2. A method according to claim 1, wherein an ultrasonic energy transmitter/receiver is located at the selected testing points directly on the contact surface of the steel strip supporting surface.

3. A method according to claim 1, wherein the pulses are transmitted at a frequency of between 6 and 10 MHz.

4. A method according to claim 2, wherein the pulses are transmitted at a frequency of between 6 and 10 MHz.

5. A method according to claim 1, wherein the pulses are transmitted at a frequency of about 8 MHz.

6. A method according to claim 2, wherein the pulses are transmitted at a frequency of about 8 MHz.
